(19) United States
(12) Patent Application Publication
(10) Pub. No.: US 2018/0048727 A1
(43) Pub. Date: Feb. 15, 2018

(54) TRANSMISSION APPARATUS AND METHOD, AND STORAGE MEDIUM

(71) Applicant: CANON KABUSHIKI KAISHA, Tokyo (JP)

(72) Inventor: Seiji Suzuki, Niigata-shi (JP)

(21) Appl. No.: 15/661,669

(22) Filed: Jul. 27, 2017

(30) Foreign Application Priority Data
Aug. 10, 2016 (JP) 2016-158128

(51) Int. Cl. H04L 29/08; H04N 21/61; H04L 29/06

(52) U.S. Cl. CPC H04L 67/26; H04L 65/4069; H04N 21/6125; H04L 67/02; H04L 65/608

(57) ABSTRACT

A transmission apparatus transmits image data divided into a plurality of segments to a reception apparatus. The transmission apparatus includes: a reception unit configured to receive a request for a segment from the reception apparatus; a decision unit configured to decide, based on information associated with the reception apparatus, whether to select a push segment subjected to push transmission to the reception apparatus; a selection unit configured to select, when the decision unit decides to select a push segment based on information associated with the reception apparatus, the push segment based on the information; and a transmission unit configured to transmit data designated by a request received by the reception unit to the reception apparatus and perform push transmission of a push segment selected by the selection unit to the reception apparatus.

### BACKGROUND OF THE INVENTION

### Field of the Invention

The present invention relates to a transmission apparatus and method, and a storage medium and, more particularly, to a data communication technique of performing streaming playback of video data.

### Description of the Related Art

In recent years, there has been provided a delivery system for delivering a content in a streaming format, which includes audio data and video data, to a user in real time. Such a delivery system allows the user to enjoy a desired content such as a live video in real time via his/her terminal apparatus.

With the widespread use of terminals such as smartphones and tablets, there have been increasing demands for enjoying streaming contents with various types of terminal apparatuses at any time and any place. In order to meet such requirement, much attention has been paid to schemes (for example, MPEG-DASH and Http Live Streaming) of dynamically changing streams to be obtained in accordance with the performance of a terminal apparatus for implementing this requirement and the communication situation in which the terminal apparatus operates. DASH stands for Dynamic Adaptive Streaming over HTTP.

These schemes are designed to divide video data into segments in small time units and describe URLs (Uniform Resource Locators) for obtaining such segments in a file called a play list. A reception apparatus obtains this play list first, and then obtains desired video data by using the information written on the play list. Describing URLs corresponding to video data segments of a plurality of versions in a play list allows the reception apparatus to obtain video data segments of optimal versions in accordance with the processing capability of the apparatus itself and its communication environment.

These streaming schemes provide, as an advanced function, a function of performing push transmission of data segments from a transmission apparatus without any explicit segment request from a reception apparatus. For example, with regard to MPEG-DASH, FDH (DASH over Full Duplex HTTP-based Protocol) is known. This scheme can reduce video playback delay by reducing transactions between a transmission apparatus and a reception apparatus.

U.K. Patent Application Publication No. 2516112 discloses a technique of making a transmission apparatus record a utilization situation data (access log) in accordance with access from a reception apparatus and decide the most frequently requested data as data subjected to push transmission to the reception apparatus based on the utilization situation data.

The arrangement disclosed in U.K. Patent Application Publication No. 2516112, however, may not allow transmission of proper push data.

For example, the following are cases in which data unintended by the user may be pushed to the reception apparatus side:

(1) When the usefulness of utilization situation data is low, data complying with a potential request from the reception apparatus may not be transmitted. When, for example, a long time has elapsed between the last communication with the reception apparatus and the new communication with the apparatus or the number of times of communication with the reception apparatus is not large enough as the number of samples to decide push transmission data, the usefulness of the utilization situation data is low. This makes it difficult to comply with a potential request from the reception apparatus.

(2) When the time between the end of the immediately preceding session and the restart of the session is short, the reception apparatus may have obtained data similar to data obtained in the previous session. When, however, the most frequently requested data differs from the data obtained in the previous session, it is impossible to comply with a potential request from the reception apparatus.

(3) When access from reception apparatuses has concentrated on a specific media constituent element (for example, a tile video), a newly connected reception apparatus may issue a request for the media constituent element on which access has concentrated. In such a case as well, it is difficult for the scheme of deciding the most frequently requested data as push transmission data to comply with a request from the reception apparatus.

The present invention solves one or more of the problems in cases (1) to (3) described above.

### SUMMARY OF THE INVENTION

According to one aspect of the present invention, there is provided a transmission apparatus which transmits image data divided into a plurality of segments to a reception apparatus, the transmission apparatus comprising: a reception unit configured to receive a request for a segment from the reception apparatus; a decision unit configured to decide, based on information associated with the reception apparatus, whether to select a push segment subjected to push transmission to the reception apparatus; a selection unit configured to select, when the decision unit decides to select a push segment based on information associated with the reception apparatus, the push segment based on the information; and a transmission unit configured to transmit data designated by a request received by the reception unit to the reception apparatus and perform push transmission of a push segment selected by the selection unit to the reception apparatus.

Further features of the present invention will become apparent from the following description of exemplary embodiments (with reference to the attached drawings).

### BRIEF DESCRIPTION OF THE DRAWINGS

FIG. 1 is a view showing the overall arrangement of a communication system;

FIG. 2 is a block diagram showing an example of the functional arrangement of a transmission apparatus;

FIG. 3 is a view showing an example of a play list;

FIG. 4 is a block diagram showing an example of the hardware arrangement of a reception apparatus;

FIG. 5 is a flowchart showing a processing procedure for push transmission data decision processing example 1;

FIG. 6 is a view showing a concrete example of processing according to push transmission data decision processing example 1;

FIG. 7 is a flowchart showing a processing procedure for push transmission data decision processing example 2;

FIG. 8 is a view showing a concrete example of processing according to push transmission data decision processing example 2;

FIG. 9 is a flowchart showing a processing procedure for push transmission data decision processing example 3; and

FIG. 10 is a view showing a concrete example of processing according to push transmission data decision processing example 3.

### DESCRIPTION OF THE EMBODIMENTS

Embodiments of the present invention will be described in detail below with reference to the accompanying drawings. The arrangement described in each of the following embodiments is merely an example, and the present invention is not limited to the concrete arrangement examples described below.

(Overall Arrangement of System)

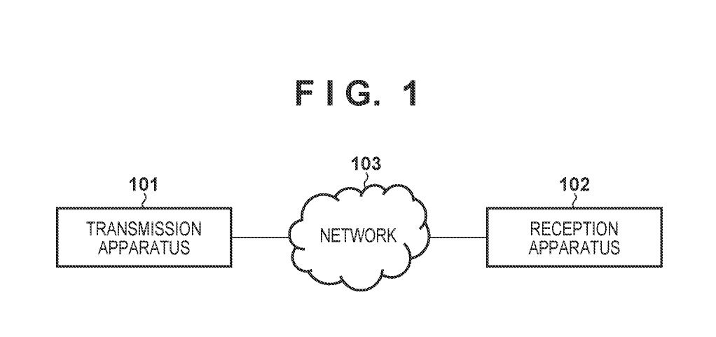

FIG. 1 is a view showing the overall arrangement of a communication system according to an embodiment of the present invention. A transmission apparatus 101 according to this embodiment is connected to a reception apparatus 102 via a network 103. Note that the embodiment may include a plurality of transmission apparatuses 101 and a plurality of reception apparatuses 102.

The transmission apparatus 101 is a transmission apparatus according to this embodiment, and has the content transmission function of transmitting image data divided into a plurality of segments to the reception apparatus. The transmission apparatus 101 may further include the function of receiving inputs from the user. Concrete examples of an apparatus for implementing the transmission apparatus 101 include information processing apparatuses such as a camera apparatus, a video camera apparatus, a smartphone apparatus, a PC (Personal Computer) apparatus, and a cell phone. However, the transmission apparatus 101 may include other types of apparatuses as long as they have the above function. Although the embodiment will exemplify the transmission apparatus 101 which transmits video data (moving image) to the reception apparatus 102, the transmission apparatus 101 may transmit sounds and the like together with still images or images.

The reception apparatus 102 is a reception apparatus according to this embodiment, and has a content playback/display function and a content communication function. This apparatus may further have the function of receiving inputs from the user. Concrete examples of an apparatus for implementing the reception apparatus 102 include a smartphone apparatus, a PC apparatus, a television set, and a cell phone. However, the reception apparatus 102 may include other types of apparatuses as long as they implement the above functional arrangement.

The network 103 is a wired LAN (Local Area Network) or wireless LAN as a network according to this embodiment. Although the embodiment uses a wired LAN or wireless LAN as a network, other types of networks may be used as long as they can communicate information. For example, such networks include a WAN (Wide Area Network) and a PAN (Personal Area Network).

(Functional Arrangement of Transmission Apparatus)

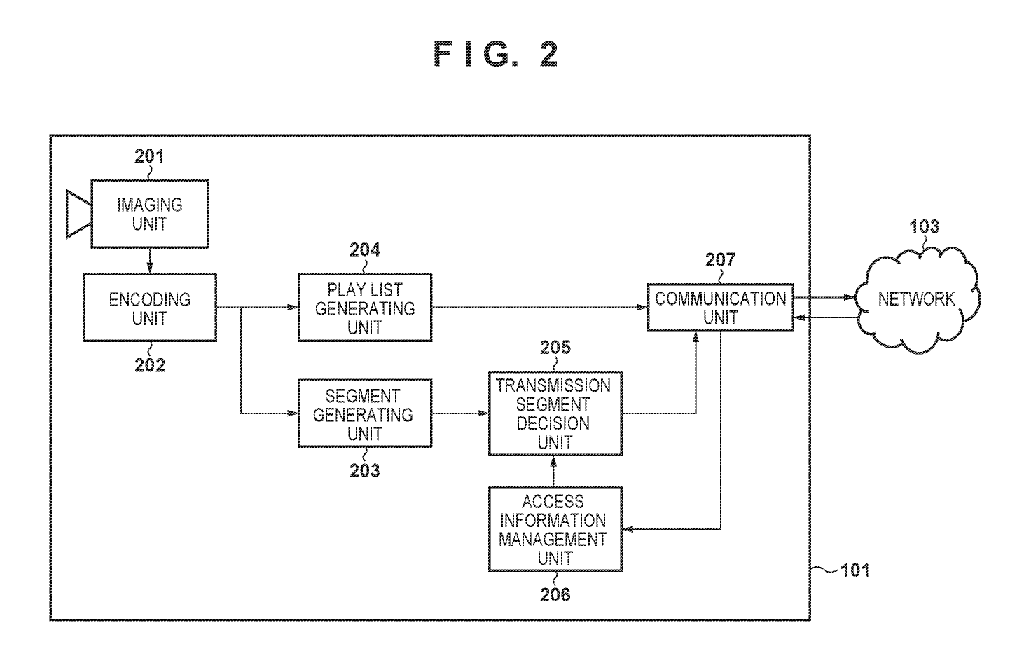

FIG. 2 is a block diagram showing the functional arrangement of the transmission apparatus 101 according to this embodiment. The transmission apparatus 101 according to this embodiment includes an imaging unit 201, an encoding unit 202, a segment generating unit 203, a play list generating unit 204, a transmission segment decision unit 205, an access information management unit 206, and a communication unit 207. The imaging unit 201 obtains video data by shooting an object. The encoding unit 202 encodes the video data obtained by the imaging unit 201 by shooting. Note that the imaging unit 201 may be located outside the transmission apparatus 101 and provide video data to the transmission apparatus 101.

The segment generating unit 203 generates segments as transmission units of video data from the video data encoded by the encoding unit 202. A segment is a unit of video data obtained by spatially or temporally dividing video data. A tile to be described later is a unit of video data obtained by spatially dividing video data. This embodiment will exemplify a case in which ISOBMFF (Base Media File Format) is used as a file format for segments. However, this is not exhaustive. For example, MPEG2TS may be used. The play list generating unit 204 generates a play list on which URLs which enable access to the segments generated by the segment generating unit 203 are written. There is available MPD (Media Presentation Description) which is defined in MPEG-DASH as a format for play lists. It is also possible to use a protocol having a function equivalent to that of MPD, including the play list description scheme in Http Livestreaming.

The communication unit 207 transmits the generated play list and segments to the reception apparatus 102 via the network 103 in accordance with requests from the reception apparatus 102. The access information management unit 206 generates access information based on a request from the reception apparatus 102, which is received by the communication unit 207, and holds the information. As described later, the access information management unit 206 stores and manages, for each reception apparatus, access information (session information) including the time of each session established between itself and the reception apparatus and information for specifying the segment transmitted to the reception apparatus in the session. Access information (session information) is information including the time of a session established with a reception apparatus and the segment transmitted to the reception apparatus in the session. The transmission segment decision unit 205 decides the segment of push transmission data, when the communication unit 207 receives a push transmission request from the reception apparatus 102, based on the access information managed by the access information management unit 206.

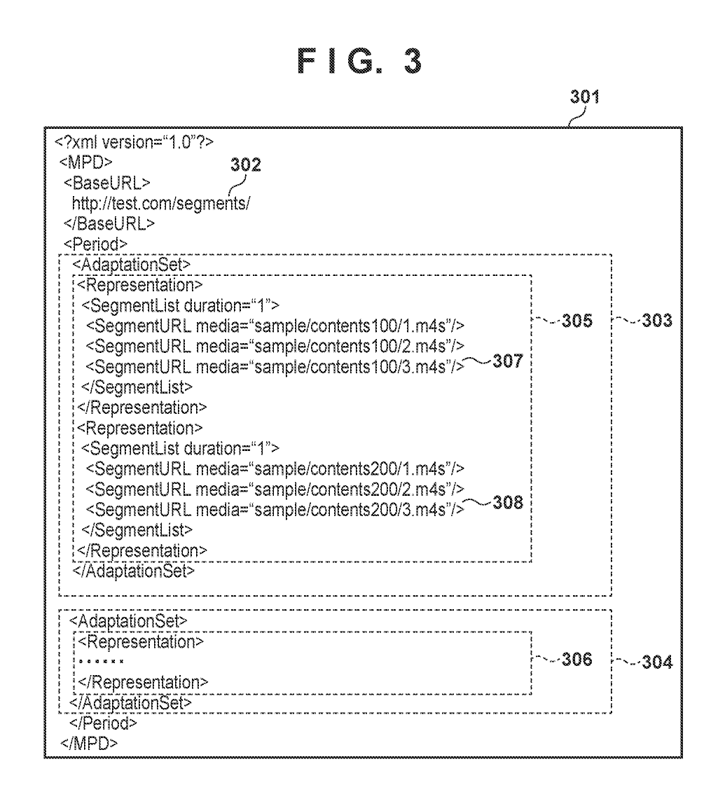

FIG. 3 is a view showing an example of a play list generated by the play list generating unit 204. This embodiment complies with a play list description scheme called MPD (Media Presentation Description) defined in MPEG-DASH. Note that the embodiment may use a protocol having a function equivalent to that of MPD, including the play list description scheme in Http Livestreaming. For the sake of descriptive simplicity, FIG. 3 does not show all the information about MPD description defined in MPEG-DASH.

FIG. 3 shows a description example 301 according to MPD. Adaptation Sets 303 and 304 each represent media constituent elements constituting media information. Media constituent elements indicate moving images, different channel or language sounds, and different language subtitles. When a video is provided upon being divided into tiles, media constituent elements correspond to each tile video. Adaption Sets include Representations 305 and 306. Each Representation is given by URLs for access to video information and segments which can be provided by the transmission apparatus 101, and is combined with Base URL 302 to issue a request for segments. In each of Representations 305 and 306, pieces of segment information for each Representation are listed in a time-series order. In each Representation list, segments with the same segment number (a serial number starting from the head of the list) are played back at the same timing. For example, segments 307 are those of contents specified by URL=“sample/contents100”, and segments 308 are those of contents specified by URL=“sample/contents200”. Contents100 (307) and contents200 (308) each are temporally divided into three segments respectively represented by “1.m4s”, “2.m4s”, and “3.m4s”. Because contents100 (307) and contents200 (308) are included in the same Adaptation Set, the playback timings of these three segments are the same. For example, “1.m4s” of contents100 (307) represents the same playback timing as that represented by “1.m4s” of contents200 (308).

(Hardware Arrangement of Transmission Apparatus)

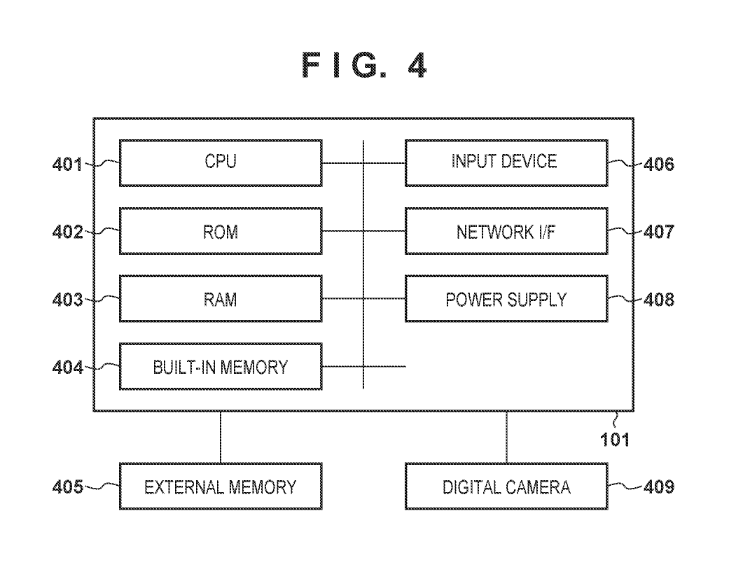

FIG. 4 is a block diagram showing the hardware arrangement of the transmission apparatus 101 according to this embodiment. A central processing unit (to be abbreviated as CPU hereinafter) 401 is a unit for calculating and processing data by controlling the overall apparatus. The CPU 401 executes programs stored in a ROM 402 (to be described later) upon loading the programs in a RAM 403 (to be described later). The CPU 401 functions as a unit for implementing the encoding unit 202, the segment generating unit 203, the play list generating unit 204, the transmission segment decision unit 205, and the access information management unit 206.

The ROM 402 is a read-only memory, which is a storage device for reading out once written information. This device stores computer programs for implementing the respective functional units shown in FIG. 2. The RAM 403 is a writable memory, which is a storage device for temporarily writing and reading out data. The RAM 403 functions as a working memory, which stores temporary values of the respective computer programs. A built-in memory 404 and an external memory 405 are external storage devices for storing application contents. The built-in memory 404 and the external memory 405 are implemented by a hard disk, an SSD, and the like.

An input device 406 is a device with which the user performs an input operation. The input device 406 is equipped with buttons such as a power button, a volume button, and a home button and implemented by a keyboard, a pointing device, a touch panel, and the like. A plurality of input devices 406 can be mounted on the transmission apparatus 101.

A network I/F 407 is a device for transmitting and receiving data via the network 103. The network I/F 407 functions as a device which implements the communication unit 207. A power supply 408 is a device which supplies power to the transmission apparatus 101 and charges it, and includes a battery and a battery charger. A digital camera 409 is a device which obtains transmission contents by shooting, and functions as a device which implements the imaging unit 201.

(Push Transmission Data Decision Processing Example 1)

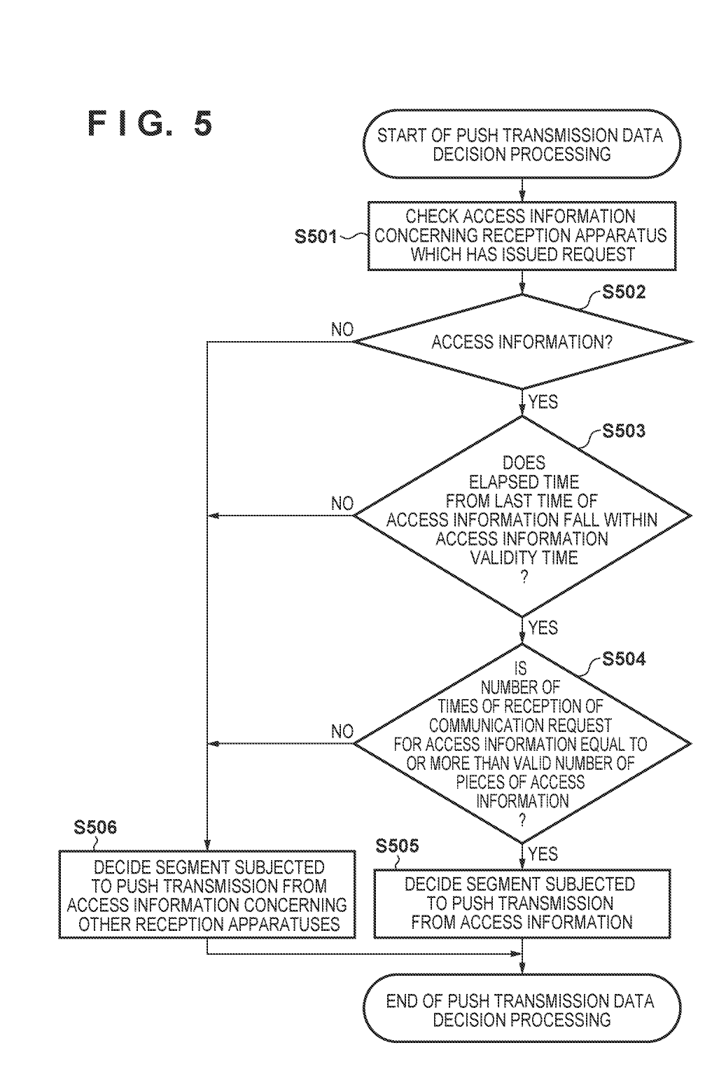

An example of the processing of deciding push transmission data (push transmission data decision processing example 1) according to this embodiment will be described with reference to FIG. 5. FIG. 5 is a flowchart showing a processing procedure for push transmission data decision processing example 1. Each step in FIG. 5 is executed under the control of the CPU 401.

In this embodiment, the transmission apparatus 101 decides a segment of image data to be transmitted in accordance with a request for image data from the reception apparatus 102, and transmits the segment to the reception apparatus 102. In this case, the transmission apparatus 101 decides a segment of image data to be transmitted based on at least the number or times of sessions established with the reception apparatus. This makes it possible to decide and transmit push data complying with a potential request from the reception apparatus in accordance with the situation information of an established session. Push transmission data decision processing example 1 will exemplify a case of determining whether session information concerning the reception apparatus from which a request for image data has been received has usefulness and switching whether to use the session information when deciding a segment.

In step S501, the transmission segment decision unit 205 checks whether the access information management unit 206 has access information concerning the reception apparatus 102 which has output a push transmission request. For example, when a play list request is received instead of a push transmission request, the transmission segment decision unit 205 may also determine that the access information management unit 206 has such access information. Alternatively, before receiving a push transmission request, the transmission apparatus 101 may determine the reception apparatus 102 which may transmit a request, and check the presence/absence of access information concerning the reception apparatus 102. In this case, the transmission apparatus 101 can determine an apparatus having an access log, an apparatus of a subscriber to a content delivery service, or the like as an apparatus which may transmit a request.

In step S502, the transmission segment decision unit 205 determines whether there is access information concerning the reception apparatus 102 which has output a request. If there is access information (YES in step S502), the process shifts to step S503. Otherwise (NO in step S502), the process shifts to step S506.

In step S503, the transmission segment decision unit 205 refers to the access information concerning the reception apparatus 102, which has output the request, to determine whether the elapsed time from the time when a communication request was last received falls within a predetermined time. The time when the communication request was received includes, for example, the time when access information was recorded, the time when a segment was transmitted to the reception apparatus 102, the time when an image data request was received from the reception apparatus 102, and the start or end time of a session with the reception apparatus 102. Note that the predetermined time is set in advance as the upper limit time within which it can be determined that access information is valid. If the access information is valid, the transmission apparatus 101 according to this embodiment decides a segment subjected to push transmission by using the access information. Lastly, if the elapsed time from the time when the communication request was last received falls within the predetermined time (YES in step S503), the process shifts to step S504. If the predetermined time has elapsed (NO in step S503), the process shifts to step S506.

In step S504, the transmission segment decision unit 205 refers to the access information concerning the reception apparatus 102, which has output the request, to determine whether the number of times of reception of a communication request is equal to or more than a predetermined number of times. The number of times of reception of a communication request which can be used includes, for example, the number of times when a session has been established with the reception apparatus 102, the number of times when a segment has been transmitted to the reception apparatus 102, and the number of times when a segment request has been received from the reception apparatus 102. A predetermined number of times is set in advance as the minimum number that makes it possible to determine that the access information is valid. If the access information is valid, the transmission apparatus 101 decides a segment subjected to push transmission by using the access information. If the number of times when a communication request has been received is equal to or more than the predetermined number of times (YES in step S504), the process shifts to step S505. If this number of times is less than the predetermined number of times (NO in step S504), the process shifts to step S506.

Note that this embodiment has exemplified the case in which determination in step S504 is performed after determination in step S503. However, the execution order of steps S503 and S504 may be reversed. Alternatively, only one of these steps may be executed.

In step S505, the transmission segment decision unit 205 decides a segment subjected to push transmission from the access information concerning the reception apparatus 102 which has issued the request. There is available a push transmission data decision scheme which specifies a segment which the reception apparatus 102 has frequently obtained based on access information, and can decide push transmission data based on the specified segment. When, for example, the reception apparatus 102 has frequently obtained a segment of a VGA-size video, the transmission segment decision unit 205 can select a segment of the VGA-size video as push transmission data. Alternatively, the transmission segment decision unit 205 may decide a segment subjected to push transmission based on, for example, the type of video (for example, a sports broadcast or news broadcast) which the reception apparatus 102 has frequently obtained or the duration of a content. Alternatively, the transmission segment decision unit 205 may decide push transmission data using a scheme other than the scheme based on a segment which the reception apparatus 102 has frequently obtained. For example, the transmission segment decision unit 205 may decide, as a transmission object, a segment having high relevance with a recently obtained segment or a segment which the reception apparatus 102 has obtained. The processing for deciding push transmission data is then terminated.

In contrast to the above, in step S506, the transmission segment decision unit 205 decides a segment subjected to push transmission from access information concerning reception apparatuses other than the reception apparatus 102 which has transmitted the request. More specifically, the transmission segment decision unit 205 analogizes a segment to be obtained by the reception apparatus 102 which has transmitted the request from access information concerning reception apparatuses having the same features (concerning a browser, a terminal type, the screen size of the terminal, and the like) as those of the reception apparatus 102 which has transmitted the request. In this case, the transmission segment decision unit 205 may analogize a segment from access information concerning one reception apparatus or access information concerning a plurality of reception apparatuses complying with conditions. For example, the transmission segment decision unit 205 may decide, as a segment subjected to push transmission, a segment which other reception apparatuses have most frequently accessed. In step S506, the transmission segment decision unit 205 may decide, as a segment subjected to push transmission, a predetermined default segment instead of deciding a segment subjected to push transmission from access information concerning reception apparatuses other than the reception apparatus 102 which has transmitted the request. For example, a default segment may be a segment having the lowest resolution.

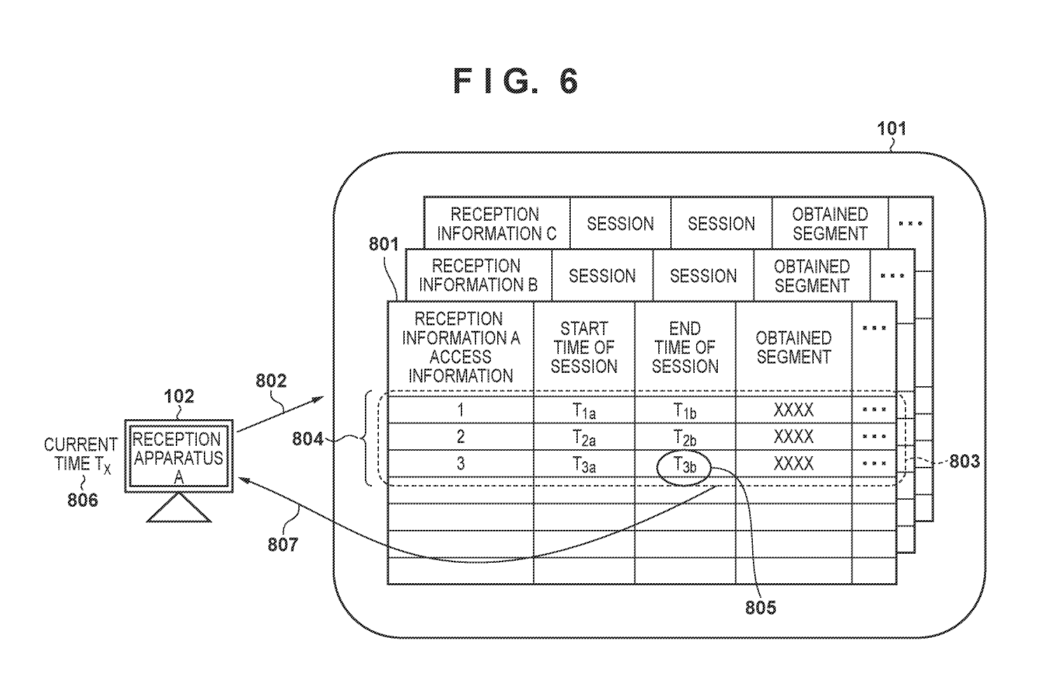

A concrete example of the execution of push transmission data decision processing example 1 will be described with reference to FIG. 6. The transmission apparatus 101 records access information 801 for each reception apparatus 102, and manages the access information by using the access information management unit 206. Every time a session is established, a record is added to the access information 801, and a record number, a session start time, a session end time, and segment information which the reception apparatus 102 has obtained at the session time, and the like are recorded. Note that some of pieces of the above information may not be recorded as the access information 801, or information other than the above information may be recorded as the access information 801. A record number is identification information for identifying the session. A larger record number indicates a newly added record. In the example shown in FIG. 6, record numbers are written in the column of “Reception Apparatus A Access Information”.

When a reception apparatus A 102 transmits a request 802 to the transmission apparatus 101, the communication unit 207 of the transmission apparatus 101 receives the request 802. In accordance with this request, the transmission apparatus 101 starts push transmission data decision processing. In step S501, the transmission segment decision unit 205 searches for access information concerning the reception apparatus A 102 to determine in step S502 that there is the access information 801 concerning the reception apparatus A 102 (YES in step S502).

In step S503, the transmission segment decision unit 205 of the transmission apparatus 101 determines whether the elapsed time from the time when a communication request was last received from the reception apparatus A 102 falls within the predetermined time. Assume that in this case, the session last time included in access information is the time when a communication request was last received. The session end time of record 3, which is the latest record of the access information 801 concerning the reception apparatus A 102, is represented by T3b 805, and the current time is represented by Tx 806. Accordingly, the elapsed time is represented by Tx−T3b. The transmission segment decision unit 205, therefore, compares Tx−T3b with the predetermined time set in advance. The following is a case in which Tx−T3b≦predetermined time, and the transmission segment decision unit 205 determines that the elapsed time falls within the predetermined time (YES in step S503).

In step S504, the transmission segment decision unit 205 of the transmission apparatus 101 determines whether the number of times of reception of a communication request from the reception apparatus A 102 is equal to or more than the predetermined number of times. Assume that in this case, a “record count 804” shown in the access information represents the number of times of reception of a communication request. In the case shown in FIG. 6, the number of times of reception of a communication request from the reception apparatus A 102 is “3” as indicated by the record count 804 of the access information 801. The following is a case in which predetermined number of times=3, and the transmission segment decision unit 205 determines that “3” of the record count 804 is equal to or more than the predetermined number of times (YES in step S504).

In step S505, the transmission segment decision unit 205 decides a segment subjected to push transmission from all records 803 of the access information 801 concerning the reception apparatus A 102, and the communication unit 207 performs push transmission of the segment as a response 807 to the reception apparatus 102. The transmission segment decision unit 205 decides, as a segment subjected to push transmission, for example, a segment which the reception apparatus A 102 has most frequently obtained.

As described above, in the above case, upon reception of a request for image data from a reception apparatus, the transmission apparatus determines whether access information (session information) concerning the reception apparatus has usefulness. More specifically, the transmission apparatus determines the usefulness of access information based on whether the elapsed time from the time when a communication request was last received from the reception apparatus falls within the predetermined time or whether the number of sessions previously established with the reception apparatus is equal to or more than the predetermined number. Upon determining that the access information has usefulness in this manner, the transmission apparatus decides a segment of image data to be transmitted to the reception apparatus based on the access information. For example, the transmission apparatus decides a segment to be transmitted based on the segment which has been most frequently transmitted to the reception apparatus. In contrast, upon determining that the access information has no usefulness, the transmission apparatus decides, based on access information concerning reception apparatuses other than the above reception apparatus, a segment of image data to be transmitted to the reception apparatus from which the request has been received. As described above, in the above case, only when access information is useful, the transmission apparatus decides a transmission object based on the access information. This makes it possible to transmit data complying with a potential request from the reception apparatus. Note, however, that upon determining that the access information concerning the reception apparatus which has transmitted the request for image data has no usefulness, the transmission apparatus may inhibit push transmission. Alternatively, the transmission apparatus may decide a segment subjected to push transmission to a reception apparatus which has transmitted a request for image data, based on access information concerning the reception apparatus and access information concerning other reception apparatuses without determining the usefulness of the access information of the reception apparatus which has transmitted the request.

(Push Transmission Data Decision Processing Example 2)

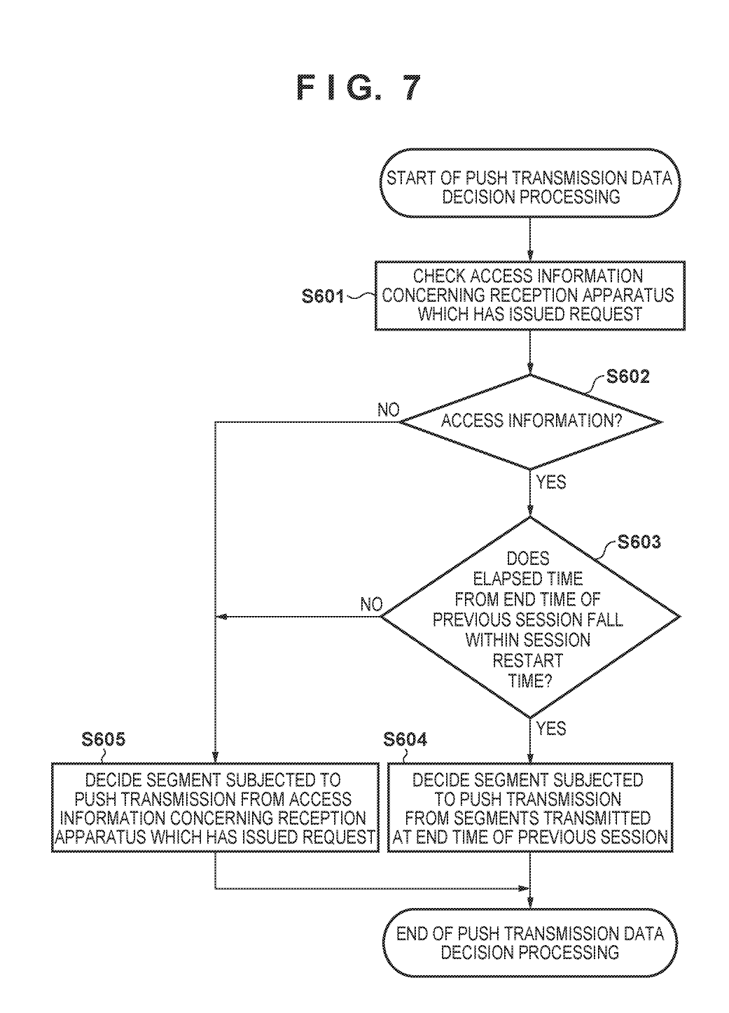

The second example of the processing of deciding push transmission data (push transmission data decision processing example 2) according to this embodiment will be described with reference to FIG. 7. FIG. 7 is a flowchart showing a processing procedure for push transmission data decision processing example 2. Each step in FIG. 7 is executed under the control of the CPU 401. Push transmission data decision processing example 2 will exemplify a case in which the CPU 401 decides a transmission object based on the last session established with a reception apparatus depending on whether the elapsed time from the time of the last session falls within a predetermined time.

The processing in step S601 is the same as that in step S501 in FIG. 5. If the CPU 401 determines that there is access information concerning the reception apparatus 102 which has transmitted a request (YES in step S602), the process shifts to step S603. Otherwise (NO in step S602), the process shifts to step S605.

In step S603, the transmission segment decision unit 205 of the transmission apparatus 101 determines whether the elapsed time from the end time of the last session established with the reception apparatus 102 falls within a session restart time. The transmission segment decision unit 205 performs this determination by referring to access information concerning the reception apparatus 102. The session restart time is set in advance as the upper limit time within which the elapsed time from the end time of an immediately preceding session with the reception apparatus 102 is short, and the transmission segment decision unit 205 determines that the reception apparatus 102 tries to establish a new session to restart the latest session ended. If the elapsed time from the end time of the immediately preceding session falls within the session restart time (YES in step S603), the process advances to step S604. If the elapsed time exceeds the session restart time (NO in step S603), the process advances to step S605.

In step S604, the transmission segment decision unit 205 decides a segment subjected to push transmission from the segments which have been transmitted at the end time of the previous session. More specifically, in the session which has been established with the reception apparatus 102 which has output a request immediately before the reception of the request, the transmission segment decision unit 205 decides push transmission data to restart the immediately preceding session from the segments which the reception apparatus 102 has obtained at the end time of the session. When, for example, the reception apparatus 102 has obtained segments of a VGA-size video at the end time of a session, the transmission segment decision unit 205 can select a segment of the VGA-size video as push transmission data. In another case, when the reception apparatus 102 has obtained segments of a specific tile video from the transmission apparatus 101, which has provided the tile video, at the end time of a session, the transmission segment decision unit 205 can select a segment of the same tile video as push transmission data. In still another example, when the reception apparatus 102 has obtained segments from the transmission apparatus 101 which has provided an on-demand service video, the transmission segment decision unit 205 can select, as push transmission data, a segment corresponding to the continuation of the video which has been interrupted at the end time of the previous session.

In contrast to the above, in step S605, the transmission segment decision unit 205 decides push transmission data from the access information concerning the reception apparatus 102 which has output the request. This processing can be performed by executing a procedure for push transmission data decision processing example 1 in FIG. 5. For example, the transmission segment decision unit 205 can decide, as a transmission object, a segment which the reception apparatus 102 has most frequently obtained. In addition, if there is no access information concerning the reception apparatus 102 which has output the request (NO in step S602) or the usefulness of the access information is low, the transmission segment decision unit 205 can decide a transmission object based on access information concerning reception apparatuses other than the reception apparatus which has output the request. This makes it possible to transmit a content complying with a potential request from the reception apparatus.

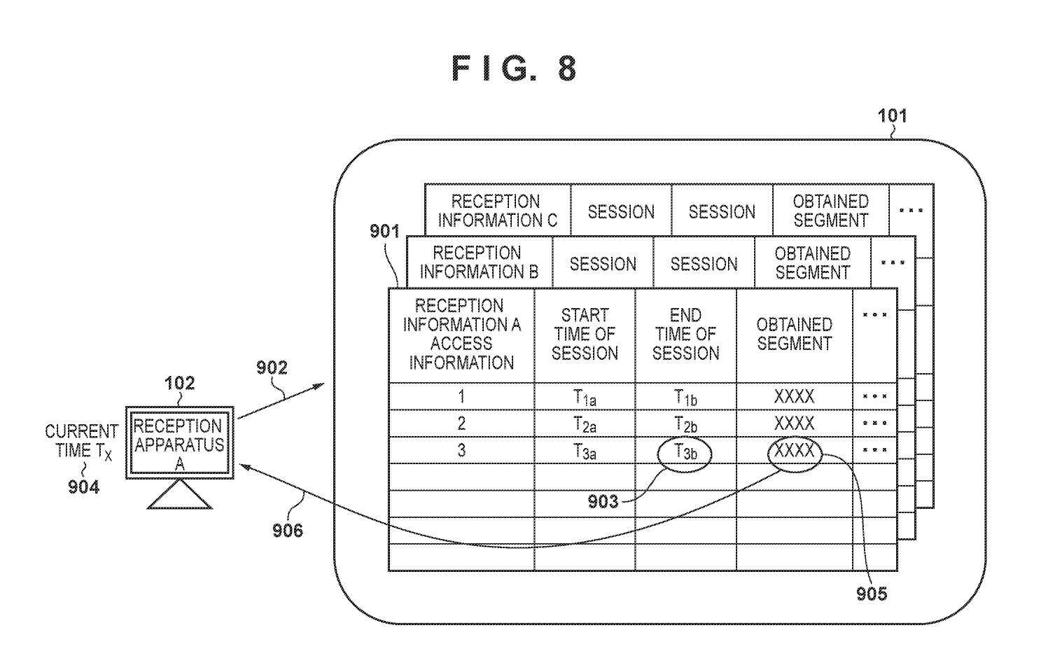

A concrete example of executing push transmission data decision processing example 2 will be described with reference to FIG. 8. The transmission apparatus 101 records and manages access information 901 for each reception apparatus 102. The access information 901 is the same as the access information 801 in FIG. 6, and a description of the information will be omitted.

When the reception apparatus A 102 transmits a request 902 to the transmission apparatus 101, the communication unit 207 of the transmission apparatus 101 receives the request 902. In response to this request, the transmission apparatus 101 starts push transmission data decision processing. In step S601, the transmission segment decision unit 205 checks whether the access information 901 includes access information concerning the reception apparatus A 102. In step S602, the transmission segment decision unit 205 determines that there is the access information 901 concerning the reception apparatus A 102 (YES in step S602).

In step S603, the transmission segment decision unit 205 of the transmission apparatus 101 refers to the access information 901 to determine whether the elapsed time from the end time of the immediately preceding session with the reception apparatus A 102 falls within the session restart time. In the case shown in FIG. 8, the session end time of record 3, which is the latest record of the access information 901 concerning the reception apparatus A 102, is represented by T3b 903, and the current time is represented by Tx 904. Accordingly, the elapsed time is represented by Tx−T3b. The transmission segment decision unit 205, therefore, compares Tx−T3b with the predetermined session restart time set in advance. The following is a case in which Tx−T3b≦session restart time, and the transmission segment decision unit 205 determines that the elapsed time falls within the session restart time (YES in step S603).

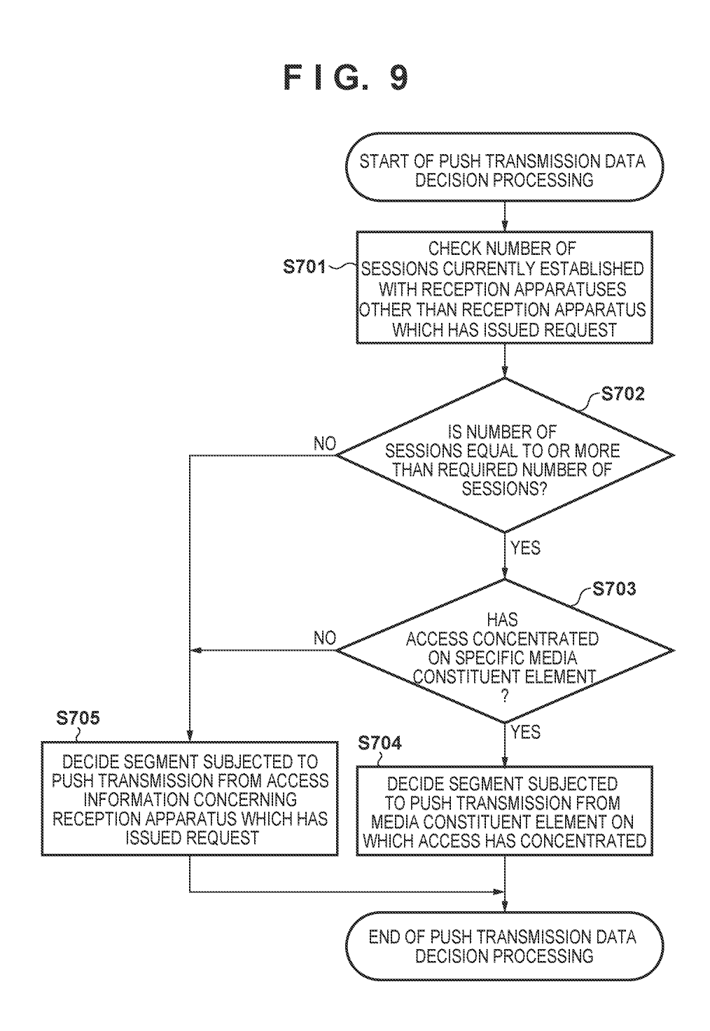

In step S604, the transmission segment decision unit 205 of the transmission apparatus 101 decides a segment of data subjected to push transmission to the reception apparatus A 102 by referring to the latest record of the access information 901 concerning the reception apparatus A 102. In the case shown in FIG. 9, the transmission segment decision unit 205 refers to an obtained segment log 905 of record 3 as the latest record of the access information 901 to decide a segment as push transmission data based on the latest obtained segment. For example, the transmission segment decision unit 205 decides a segment temporally following the latest obtained segment as a transmission object. The communication unit 207 then transmits a response 906 to the reception apparatus A 102.

As described above, in the above case, in response to the reception of a request for imaged data from a reception apparatus, the transmission apparatus determines whether the elapsed time from the time of the last session established with the reception apparatus falls within a predetermined time. Upon determining that the elapsed time falls within the predetermined time, the transmission apparatus decides a segment to be transmitted based on the segment transmitted in the last session. For example, the transmission apparatus decides, as a transmission object, a segment temporally following the segment transmitted in the last session. In contrast, upon determining that the elapsed time does not fall within the predetermined time, the transmission apparatus decides a transmission object in accordance with access information concerning the reception apparatus or access information concerning other reception apparatuses. With this operation, when the time interval between the end of the immediately preceding session and session restart is short, the transmission apparatus can comply with a potential request from the reception apparatus by transmitting data similar to the data which has been transmitted in the previous session. This makes it possible to transmit push data corresponding to information concerning a session.

(Push Transmission Data Decision Processing Example 3)

The third example of the processing of deciding push transmission data (push transmission data decision processing example 3) according to this embodiment will be described with reference to FIG. 9. FIG. 9 is a flowchart showing a processing procedure for push transmission data decision processing example 3. Each step in FIG. 9 is executed under the control of the CPU 401. Push transmission data decision processing example 3 will exemplify a case in which when the number of sessions established with reception apparatuses other than the reception apparatus which has output a request is equal to or more than a predetermined number, the CPU 401 decides a transmission object based on the distribution of access to the respective segments from other reception apparatuses.

In step S701, the transmission segment decision unit 205 of the transmission apparatus 101 checks the number of sessions established with the reception apparatuses 102 other than the reception apparatus 102 which has output the request at the time when the transmission apparatus 101 has received the request from the reception apparatus 102.

In step S702, the transmission segment decision unit 205 determines whether the number of established sessions is equal to or more than a required number of sessions. The required number of sessions is a value set in advance as the lower limit value that makes it valid to determine in step S703 (to be described later) that access has concentrated on a specific media element. Assume that the transmission segment decision unit 205 determines in step S703 (to be described later) that there is a media constituent element on which access has concentrated. Even in this case, if the total number of sessions as samples is not equal to or more than the required number of sessions, because the parameter with respect to the samples is not sufficient, the transmission segment decision unit 205 determines that the access concentration determination is not valid. If the transmission segment decision unit 205 determines that the number of established sessions is equal to or more than the required number of sessions (YES in step S702), the process shifts to step S703. If the transmission segment decision unit 205 determines that the number of established sessions is not equal to or more than the required number of sessions (NO in step S702), the process shifts to step S705.

In step S703, the transmission segment decision unit 205 determines whether there is any of media constituent elements such as a specific language sound and a tile video on which access from the reception apparatuses 102 other than the reception apparatus 102 which has output the request has concentrated. The transmission segment decision unit 205 determines that access has concentrated on a specific media constituent element when the ratio of the number of sessions requesting the specific media constituent element to the total number of sessions is equal to or more than a predetermined value. The predetermined value is a value set in advance as a sufficient value that makes it possible to determine that access has concentrated on a specific media constituent element. The predetermined value may be set to, for example, a value equal to or more than 50%. The transmission segment decision unit 205 may determine the concentration of access by using the number of sessions requesting a specific media constituent element instead of the ratio of access. If the transmission segment decision unit 205 determines that there is a media constituent element on which access from reception apparatuses other than the reception apparatus 102 which has output the request has concentrated (YES in step S703), the process shifts to step S704. Otherwise (NO in step S703), the process shifts to step S705.

Note that only reception apparatuses 102 having the same features (concerning a browser, a terminal type, the screen size of the terminal, and the like) as those of the reception apparatus 102 which has output the request may be regarded as targets when the number of sessions and the ratio of access are checked in steps S702 and S703.

In step S704, the transmission segment decision unit 205 decides push transmission data from the media constituent element, determined in step S703, on which access from the reception apparatuses 102 other than the reception apparatus 102 which has output the request has concentrated. If, for example, access has concentrated on a specific tile video, the transmission segment decision unit 205 can select a segment of the tile video, as push transmission data, on which access has concentrated.

In step S705, the transmission segment decision unit 205 decides push transmission data from the access information concerning the reception apparatus 102 which has output the request by executing the procedure for push transmission data decision processing example 1 in FIG. 5.

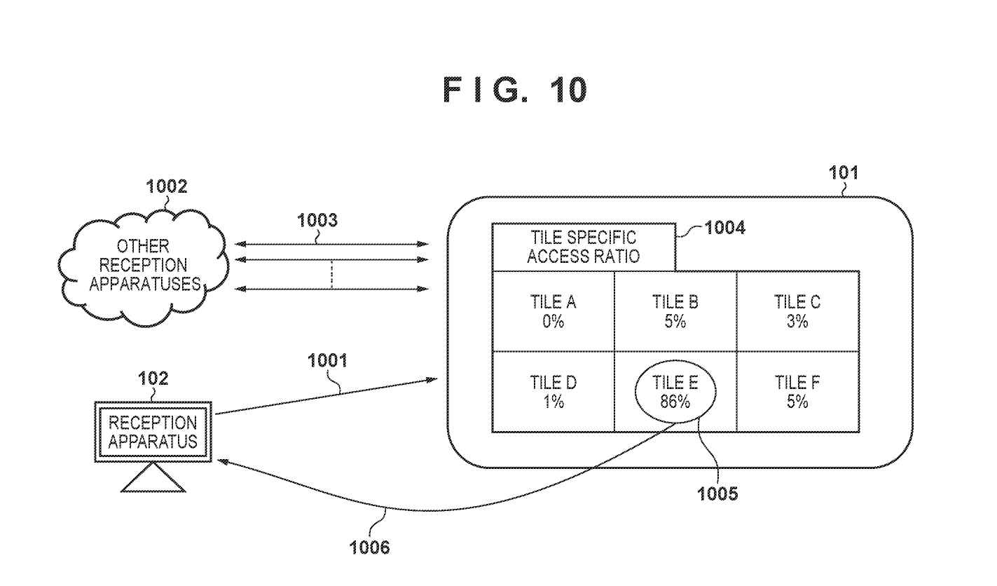

A concrete example of executing push transmission data decision processing example 3 will be described with reference to FIG. 10. The transmission apparatus 101 provides tile videos obtained by dividing a video into tiles, and manages an access ratio 1004 of each tile video. In the case shown in FIG. 10, obviously, the access ratio of tile A is 0%, and the reception apparatus 102 and other reception apparatuses 1002 have not accessed tile A at all. In addition, obviously, the access ratio of tile E is 86%, which is the highest ratio.

The reception apparatus 102 transmits a request 1001 to the transmission apparatus 101, and the communication unit 207 of the transmission apparatus 101 receives the request 1001.

In step S701, the transmission segment decision unit 205 checks a session count 1003 representing the number of sessions which have been established with the reception apparatuses 1002 other than the reception apparatus 102 which has transmitted the request 1001.

In step S702, the transmission segment decision unit 205 determines whether the session count 1003 checked in step S702 is equal to or more than a required session count. The following is a case in which session count 1003≧required session count.

In step S703, the transmission segment decision unit 205 determines from the tile specific access ratio 1004 whether access has concentrated on a specific tile. The following is a case in which the access ratio of tile E 1005 is 86%, which is the highest ratio, and the transmission segment decision unit 205 determines that access ratio≧predetermined value and access has concentrated on tile E 1005.

In step S704, the transmission segment decision unit 205 decides a segment of tile E 1005 as a segment of push transmission data, and the communication unit 207 transmits a response 1006 to the reception apparatus 102.

As described above, in the above case, in response to the reception of a request for image data from a reception apparatus, the transmission apparatus determines whether the number of sessions established with reception apparatuses other than the above reception apparatus is equal to or more than the predetermined number. Upon determining that the number of sessions is equal to or more than the predetermined number, the transmission apparatus decides a segment to be transmitted to the reception apparatus from which the request has been received, based on the distribution of access to the respective segments from the other reception apparatuses. More specifically, the transmission apparatus further determines whether access from other reception apparatuses has concentrated on a specific segment. Upon determining that access has concentrated on a specific segment, the transmission apparatus decides the segment as a segment to be transmitted to the reception apparatus from which the request has been received. In this manner, when access has concentrated on a specific segment, the transmission apparatus decides the segment as a transmission object. This makes it possible to automatically decide and transmit a segment considered to be popular and exhibit a high potential need.

As has been described above, according to each embodiment of the present invention, it is possible to efficiently decide and transmit push transmission data complying with a potential request from a reception apparatus. This makes it possible to transmit push transmission data in accordance with information concerning a session.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-158128, filed Aug. 10, 2016, which is hereby incorporated by reference herein in its entirety.

What is claimed is:

1. A transmission apparatus which transmits image data divided into a plurality of segments to a reception apparatus, the transmission apparatus comprising:
a reception unit configured to receive a request for a segment from the reception apparatus;
a decision unit configured to decide, based on information associated with the reception apparatus, whether to select a push segment subjected to push transmission to the reception apparatus;
a selection unit configured to select, when the decision unit decides to select a push segment based on information associated with the reception apparatus, the push segment based on the information; and
a transmission unit configured to transmit data designated by a request received by the reception unit to the reception apparatus and perform push transmission of a push segment selected by the selection unit to the reception apparatus.

2. The transmission apparatus according to claim 1, wherein the decision unit decides, based on an elapsed time from a disconnection timing of a session established in the past between the transmission apparatus and the reception apparatus, whether to select a push segment based on the information.

3. The transmission apparatus according to claim 2, wherein the decision unit decides to select a push segment based on the information when the elapsed time is not less than a predetermined time.

4. The transmission apparatus according to claim 3, wherein the decision unit decides not to select a push segment based on the information when the elapsed time is not less than the predetermined time.

5. The transmission apparatus according to claim 1, wherein the decision unit decides, based on an elapsed time from an establishment timing of a session established between the transmission apparatus and the reception apparatus, whether to select a push segment based on the information.

6. The transmission apparatus according to claim 1, wherein the decision unit decides, based on the number of sessions established between the transmission apparatus and the reception apparatus in the past, whether to select a push segment based on the information.

7. The transmission apparatus according to claim 1, wherein the information includes transmission information concerning a segment which has already been transmitted from the transmission apparatus to the reception apparatus, and
the selection unit selects the push segment based on the transmission information.

8. The transmission apparatus according to claim 7, wherein the transmission information includes at least one of pieces of information including a size, resolution, bit rate, language, and tile information of a segment.

9. The transmission apparatus according to claim 1, wherein the selection unit selects, as the push segment, a segment corresponding to the same video as that to which a segment transmitted by using a session established in the past corresponds.

10. The transmission apparatus according to claim 1, wherein when the decision unit decides not to select a push segment based on information associated with the reception apparatus, the transmission unit performs no push transmission to the reception apparatus.

11. The transmission apparatus according to claim 1, wherein when the decision unit decides not to select a push segment based on information associated with the reception apparatus, the selection unit selects a push segment to be push transmitted to the reception apparatus based on information associated with other reception apparatuses.

12. The transmission apparatus according to claim 1, further comprising a detection unit configured to detect the number of reception apparatuses which have established sessions with the transmission apparatus in response to reception of a request from the reception apparatus by the reception unit,
wherein the decision unit decides, based on the number of reception apparatuses detected by the detection unit, whether to select a push segment based on the information.

13. The transmission apparatus according to claim 12, wherein when the number of reception apparatuses detected by the detection unit is not less than a predetermined number, the decision unit decides to select a push segment based on information associated with the reception apparatuses detected by the detection unit.

14. The transmission apparatus according to claim 13, wherein when the decision unit decides to select a push segment based on information associated with a reception apparatus detected by the detection unit, the selection unit selects, as a push segment, a segment accessed by the reception apparatus detected by the detection unit.

15. A method of transmitting image data divided into a plurality of segments to a reception apparatus, the method comprising:
receiving a request for a segment from the reception apparatus;
deciding, based on information associated with the reception apparatus, whether to select a push segment subjected to push transmission to the reception apparatus;
selecting, when it is decided to select a push segment based on information associated with the reception apparatus, the push segment based on the information;
transmitting data designated by the received request to the reception apparatus; and
performing push transmission of the selected push segment to the reception apparatus.

16. A storage medium storing a program for causing a computer to execute a method of transmitting image data divided into a plurality of segments to a reception apparatus, the method comprising:
receiving a request for a segment from the reception apparatus;
deciding, based on information associated with the reception apparatus, whether to select a push segment subjected to push transmission to the reception apparatus;
selecting, when it is decided to select a push segment based on information associated with the reception apparatus, the push segment based on the information;
transmitting data designated by the received request to the reception apparatus; and
performing push transmission of the selected push segment to the reception apparatus.
